(19) United States
(12) Patent Application Publication
(10) Pub. No.: US 2018/0345625 A1
(43) Pub. Date: Dec. 6, 2018

(54) MARKING ELEMENT

(71) Applicant: VETEX nv, Ingelmunster (BE)

(72) Inventors: Gert RAEYMACKERS, Wetteren (BE); Steven DE SMET, Waregem (BE); Jurgen MISPELON, Beerst (BE)

(21) Appl. No.: 15/609,699

(22) Filed: May 31, 2017

(51) Int. Cl. B32B 7/12; B32B 5/02; B32B 27/12; B32B 27/40

(52) U.S. Cl. CPC B32B 7/12; B32B 5/02; B32B 2519/00; B32B 27/40; B32B 2307/704; B32B 27/12

(57) ABSTRACT

A removable marking element for the labelling of a textile comprises a fabric layer, having an upper surface and a lower surface opposite to the upper surface, and an adhesive layer for securing the marking element to a textile by heat and pressure, wherein said adhesive layer is bonded to the lower surface of the fabric layer, wherein the adhesive layer is composed of at least two sublayers, including a first sublayer forming an outer layer of the marking element and comprising a thermoplastic urethane for securing the marking element to the textile by heat and pressure, and a second sublayer bonded to the first sublayer and located between the first sublayer and the fabric layer, wherein the second sublayer comprises a thermoset.

### FIELD OF THE INVENTION

This invention concerns a marking element for the labelling of a textile, wherein said marking element comprises a fabric layer, having an upper surface and a lower surface opposite to the upper surface, and an adhesive layer for securing the marking element to a textile by heat and pressure, wherein said adhesive layer is bonded to the lower surface of the fabric layer.

These marking elements often comprise a logo, a barcode, a name, etc. which is applied to the upper surface of the fabric layer. The appliance of said logo, barcode, name, etc. can for example be done by thermal printing, embroidery, digital printing or sublimation. For attaching a said marking element to a textile, heat and pressure is applied. Under the influence of heat, at least part of the adhesive of the adhesive layer liquefies. With the aid of pressure, said liquefied adhesive is then partly pressed into the textile. The adhesive than hardens again during the cooling down, with the result that the marking element is attached to the textile. For said attachment a patch machine can be used. Such a patch machine will for example apply a pressure situated between 3 and 5 bar and apply a temperature situated between 190° C. and 205° C. and this for at least 10 seconds. For certain marking elements sufficient heat and pressure can also be applied by ironing.

### BACKGROUND

Marking elements, such as emblems, labels and tapes, are used to mark textiles, such as clothes, sheets, towels, etc. They are specifically used for the labelling of working clothes, uniforms, sheets and/or towels in hotels, hospitals, retirement homes, etc.

There are two large groups of marking elements, namely permanent marking elements and temporary marking elements. Temporary marking elements are meant to be temporarily attached to a textile, such that they can stay attached the textile for one washing cycle. Such temporary marking elements can for example be used in hotels for the labelling of clothes that need to be washed, wherein said clothes are the property of guests. By labelling said clothes it is ensured that the clothes return to the right guests.

Permanent marking elements are mainly used to label working clothes and/or uniforms, such that said textiles have the desired logo, name, barcode, etc. They are meant to stay attached to a said textile even after several industrial and/or domestic washing cycles of the textile. Industrial washing cycles are washing cycles with a maximum temperature of approximately 95° C. Domestic washing cycles for clothes often do not reach temperatures higher than 60° C. By several washing cycles, more than 50 washing cycles are meant. The problem that arises here is that after a certain amount of time, the logo of a firm can change, employees retire or resign, employees change function, etc. Often, the used textiles are still in good condition, however the marking element attached to it is no longer the desired marking element. It is then desired to remove the marking element. However, removing such a permanent marking element damages the textile and/or leaves residues of the adhesive of the adhesive layer on the textile. This means that said textile can no longer be used and/or a larger marking element needs to be attached to the damaged place of the textile to cover up said place. Another problem that can arise is that emblems/labels are attached to uniforms which are no longer suitable, for example the uniforms get too small or the quality is decreased. It can then be desired to remove these emblems/labels and attach them to another uniform. With the known permanent marking elements, this is not possible because they can no longer be used after their removal from a textile.

### SUMMARY

It is an object of the invention to solve the abovementioned problems and to provide a marking element which can stay attached to a textile for several (industrial) washing cycles, but which can also be removed when desired and this without damaging and/or defiling the textile.

This object is achieved by providing a marking element for the labelling of a textile, wherein said marking element comprises a fabric layer, having an upper surface and a lower surface opposite to the upper surface, and an adhesive layer for securing the marking element to a textile by heat and pressure, wherein said adhesive layer is bonded to the lower surface of the fabric layer, and wherein the adhesive layer is composed of at least two sublayers, including a first sublayer for securing the marking element to the textile by heat and pressure, wherein said first sublayer forms an outer surface of the marking element and a second sublayer located between the first sublayer and the fabric layer, wherein the second sublayer comprises a thermoset.

A thermoset is a polymer which cannot be melted and reformed and is therefore a durable polymer. A second sublayer comprising a said thermoset thus forms a good barrier between the first sublayer and other layers, such as the fabric layer, or possible other sublayers of the adhesive layer. Preferably the second sublayer substantially comprises one or more thermosets. More preferably the second sublayer is mainly made of a thermoset.

Said marking element is meant to be attached to a textile by applying heat and pressure. The attachment of a said marking element can be referred to as the patching of the marking element to the textile. This patching is normally done at standard conditions. For example standard conditions can be a temperature between 150° C. and 205° C., a pressure between 3 and 5 bar and a duration of between 8 and 15 seconds. Some marking elements can also be applied with the use of an iron, such that the patching is done at temperatures below 200° C. and at lower pressures. Preferably during the patching of the said marking element, the second sublayer remains in its same condition and therefore does not alter, or melt or degrade. Therefore the second sublayer forms a good barrier between the first sublayer and the rest of the marking element and the first sublayer cannot mix with other layers/sublayers of the marking element. Under the influence of heat, the first sublayer will (partly) liquefy and with the aid of pressure, this liquefied first sublayer is partly pressed into the said textile, as such attaching the marking element to the textile. Because of said second sublayer, the first sublayer cannot mix with the other layers/sublayers of the marking element, when said first sublayer is at least partly liquefied during the patching of the marking element to a textile. This also means that with the aid of pressure, only the said first sublayer can be partly pressed into the textile. This ensures a good bond between the marking element and a textile.

This also means that the first sublayer can be made of a substance which can form a good bond between the marking element and the textile, without the risk that this first sublayer gets befouled with substances of another sublayer or layer. Here one can provide that the adhesive layer stays permanently attached to the fabric layer, without the risk of befouling the first sublayer with elements/substances which inhibit a good removal of the marking element from the textile when desired. The first sublayer can thus be substantially made of one or several substances which can attach to the textile with heat and pressure, and which will stay attached to the textile even after several industrial washing cycles, but which can also be removed without hardly leaving residues and/or damaging the textile. The removing of the marking element may be done by heat and pressure. This marking element can thus be made removable, without the risk that the fabric layer of the marking element comes loose from the adhesive layer. After its removal the marking element can be reused.

The phrase ‘said adhesive layer is bonded to the lower surface of the fabric’ means that said adhesive layer is bonded to the fabric layer at the level of the lower surface of the fabric layer. For this bond, the adhesive layer may be partly penetrated into the fabric layer at the level of the lower surface of the fabric layer.

In an embodiment, the first sublayer comprises a thermoplastic urethane. Said thermoplastic urethane may be a polyester-based thermoplastic urethane. Such urethanes are well suited to attach to a textile. One can thus provide a first sublayer substantially comprising a thermoplastic urethane which can attach well to a textile with the aid of heat and pressure, but which can also be easily removed from the textile with the aid of heat and pressure. Further, the first sublayer may be substantially made of one or several thermoplastic urethanes. More particularly, the first sublayer may be mainly made of a thermoplastic urethane.

In embodiments, the second sublayer is bonded to the first sublayer. This ensures that the second sublayer forms a good barrier between the first sublayer and other layers of the marking element or sublayers of the adhesive layer. For this bond, the first sublayer may be partly penetrated into the second sublayer at the level of the surface of the second sublayer.

In a specific embodiment, the second sublayer comprises a thermoset urethane. Thermoset urethanes are known for their high decomposition temperature and their good durability. The second sublayer may be substantially made of one or several thermoset urethanes. More particularly the second sublayer may be mainly made of a thermoset urethane.

In an embodiment, the thermoset has a decomposition temperature of above 205° C. Since patch machines and irons, which can be used to attach a said marking element, will normally not apply a temperature of above 205° C., this means that the second sublayer will not decompose or alter during the attachment of the marking element to a textile. The second sublayer can thus always perform its barrier function. The thermoset may have a decomposition temperature of above 210° C., or even above 220° C.

In a specific embodiment, the adhesive layer comprises a third sublayer located between the second sublayer and the fabric layer. Said third sublayer may include a thermoplastic urethane and more particularly said thermoplastic urethane may be a polyester-based thermoplastic urethane. Also the adhesive layer may consist of only said three sublayers.

In this specific embodiment the third sublayer may be bonded to the lower surface of the fabric layer and to the second sublayer. The second sublayer here forms a barrier between the first sublayer and the third sublayer. The composition of the first sublayer preferably differs from the composition of the third sublayer. The composition of the first sublayer is such that it can bind the marking element to the textile in such a way that the marking element can be removed from the textile by applying heat and pressure, without leaving residues and/or damaging the textile. The composition of the third sublayer is such that it will provide a virtually permanent bound between the second sublayer and the fabric layer, such that it is very difficult to detach the fabric layer from the adhesive layer. Preferably the bond between the fabric layer and the third sublayer is stronger than the bond between the first sublayer and the textile, after attaching the marking element to the textile. With the aid of heat and pressure the bond between the marking element and the textile can be undone, such that the marking element can be removed from the textile without compromising the bond between the fabric layer and the adhesive layer.

In an embodiment, the degree of crystallinity of the third sublayer is higher than the degree of crystallinity of the first sublayer. During the patching of the marking element to a textile, at least part of the first sublayer will liquefy and will be pressed into the textile. Also part of the third sublayer can liquefy. After the patching, the marking element and textile will cool down, and the first sublayer and the third sublayer (if liquefied) will harden. During the cooling down and the hardening, crystallization can occur. The amount of crystallization will depend on the crystallinity of said sublayers. Because the degree of crystallinity is higher for the third sublayer, the third sublayer will virtually permanently and well attach to other layers and sublayers. This because the third sublayer will form crystals into the said layers and sublayers, therefore ensuring a good and virtually permanent attachment. Therefore the different layers of the marking element will not come loose from each other during the patching of the marking element or during the removing of the marking element from the textile. The third sublayer is then preferably made of one or several more crystalline polyester-based thermoplastic urethanes. During the patching of the marking element, the first sublayer will at least partly liquefy and be pressed partly into the textile. During the cooling down the first sublayer will harden again. The first sublayer is preferably made of one or several more amorphous substances, such as amorphous polyester-based thermoplastic urethanes. Because of this, the said first sublayer will not or will hardly crystalize and form a more or less amorphous structure within the textile. Because of said amorphous structure, this first sublayer will easily and (almost) completely loosen from the textile, during the removing of the to-the-textile-attached marking element, with the aid of heat and pressure. This ensures that the marking element can be removed without damaging the textile and also without leaving (almost) any adhesive residue. Also, because of the more amorphous structure, the risk of bladder formation is lower. Here, the adhesion strength of the third sublayer is greater than the adhesion strength of the first sublayer. When a marking element which has been attached to a textile, is removed from said textile by applying heat and pressure to the marking element and the textile, the adhesive power between the marking element and the textile will only slowly return when the marking element cools down, because the first sublayer has a more amorphous structure. This means that, immediately after said appliance of heat and pressure, the marking element can easily be removed from the textile.

The degree of crystallinity of the said sublayers can be determined with the aid of DSC curves (Differential scanning calorimetry). For example one can make DSC curves with the aid of the standards ASTM D3418 and/or ISO11357. Here the test sample is first cooled to −50° C. before starting the measurement. Then warming up is done at 10° C./min up to 200° C. After this, there is another cooling at 10° C./min up to −50° C. Finally the sample is warmed up again at 10° C./min up to 200° C.

In an embodiment the thickness of the first sublayer is between 30 and 70 g/m², for example between 40 and 60 g/m². With such a thickness, the first sublayer is sufficiently thick to ensure a good bond between the marking element and a textile, wherein said bond can withstand several (industrial) washing cycles. Also there is not too much of said first sublayer such that during the patching of the marking element, the first sublayer does not penetrate throughout the entire thickness of textile and there is no undesired bladder formation. With such thickness of the first sublayer, a textile with such a marking element attached to it can be washed more than 50 times without the marking element coming loose from the textile.

In embodiments, the thickness of the second sublayer is between 5 and 45 g/m², for example between 15 and 35 g/m². The thickness of this second sublayer is here sufficient, such that the second sublayer can form a good barrier between the first sublayer and other sublayers/layers. For example in a said embodiment with a third sublayer, this second sublayer will ensure that the third sublayer and the first sublayer will not mix during the patching of the marking element to a textile. This second sublayer thus ensures that the first sublayer will not be befouled with parts of the third sublayer, such that a good removal of the marking element from the textile is ensured, when it is desired to remove the marking element. The thickness of the second sublayer may also not be too large, because this second sublayer forms a heat insulator between the first sublayer and the rest of the marking element. There are different ways to attach the marking element to the textile. Heat and pressure is always used, however one can choose to apply heat only to the upper side of the marking element, or to the upper side of the marking element and to the lower side of the textile. When one only applies heat to the upper side, the thickness of the second sublayer may not be too large, such that the temperature of the first sublayer can rise enough during the patching of the marking element, such that a good attachment of the marking element to the textile is ensured. Also during the removing of the marking element, heat transfer to the first sublayer must also be sufficient.

In another specific embodiment the thickness of the third sublayer is between 40 and 80 g/m², for example between 50 and 70 g/m². This ensures that there is enough of the third sublayer such that the entire third sublayer is not completely absorbed by the fabric layer. This also ensures that there is not too much of the third sublayer such that the entire thickness of the fabric layer is not soaked with the third sublayer and such that no bladders are formed.

In embodiments, the first sublayer comprises tackifiers. This increases the stickiness of the marking element to a textile and reduces the bladder formation during the attachment of the marking element to a said textile. To reduce the bladder formation the first sublayer can also or alternatively comprise a plasticizer and/or a wax.

In an embodiment, the first sublayer comprises a polyester-based thermoplastic urethane with a melt volume-flow rate according to ISO1133 situated between 10 and 15 g/10 min. This ensures a good flow of the first sublayer into a said textile during the attachment of the marking element to the textile and thus a good attachment. Said melt-flow rate is measured using the test conditions of ISO1133 at 180° C. and 2,16 kg load. The third sublayer may comprise another polyester-based thermoplastic urethane with a said melt volume-flow rate between 10 and 15 g/10 min.

In embodiments, the first sublayer comprises a polyester-based thermoplastic urethane with a melting temperature between 120° C. and 140° C.

In embodiments, the third sublayer comprises a polyester-based thermoplastic urethane with a melting temperature between 140° C. and 190° C.

This invention also concerns a method of removing the marking element according to the invention, which has been attached to a textile by heat and pressure, wherein to remove the marking element, heat and pressure is applied for a period between 2 and 12 seconds, and wherein the maximum applied pressure is between 2 and 5 bar and the maximum applied temperature is between 120° C. and 205° C.

Here, the marking element can be removed relatively fast and without leaving any residue of the first sublayer on the textile. This means that marking elements can be removed at a high pace. Even at relatively low temperatures, the marking element can be removed from the textile. After the heat and pressure is applied on the textile at the spot where the marking element is attached to the textile, the marking element may be immediately removed from the textile. The marking element then has virtually no time to cool down, such that adhesion between the marking element and the textile cannot be restored.

In an embodiment, the said heat and pressure is applied for less than 8 seconds, for example less than 6 seconds and in further example for 5 seconds. This ensures a removal of marking elements at a high pace. Also this ensures that the bond between the adhesive layer and the fabric layer is not compromised and thus that the marking element can be rapidly removed from the textile after the said appliance of heat and pressure.

### BRIEF DESCRIPTION OF THE DRAWINGS

FIG. 1 presents a schematic representation of a cross section of a first embodiment of a marking element according to the invention;

FIG. 2 presents a schematic representation of a cross section of a second embodiment of a marking element according to the invention;

FIG. 3 presents a DSC curve of the third sublayer;

FIG. 4 presents a DSC curve of the first sublayer.

### DETAILED DESCRIPTION OF THE DRAWINGS

The invention will now be described in greater depth based on the following detailed description of two embodiments of marking elements according to the invention. The purpose of this description is to give illustrative examples and to indicate further advantages and special features of embodiments according to this invention and should not be interpreted as a limitation of the scope of the application of the invention or of the patent rights requested in the claims. This detailed description employs reference numerals to refer to the appended drawings.

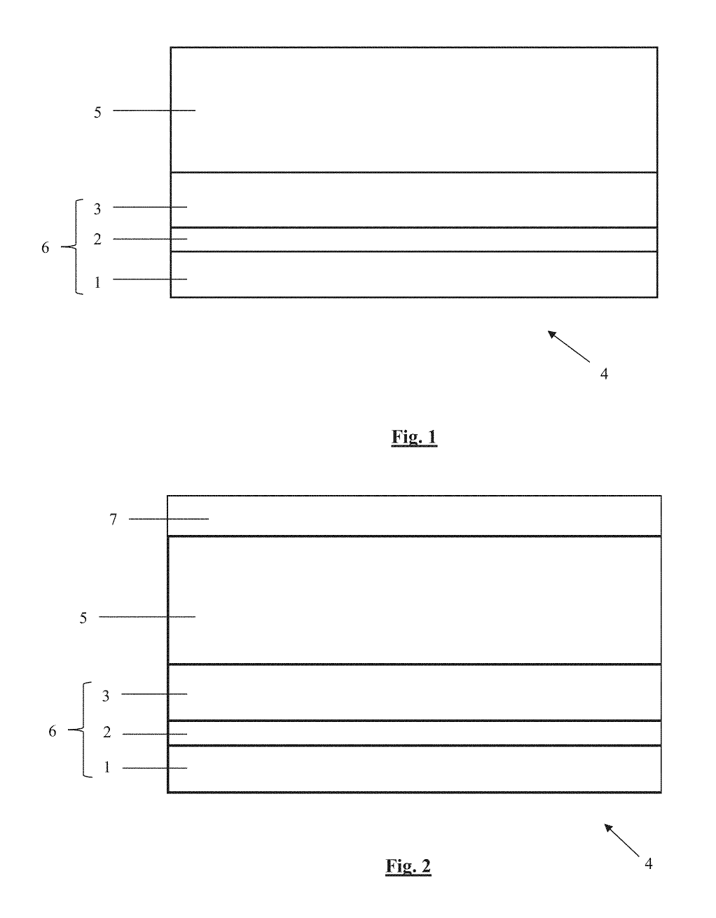

Embodiments of marking elements (4) according to the invention are illustrated in FIGS. 1 and 2. These marking elements (4) comprises a fabric layer (5) and an adhesive layer (6). This fabric layer (5) comprises an upper surface and a lower surface opposite to the upper surface. The function of the adhesive layer (6) is to secure the marking element (4) to a textile by the appliance of heat and pressure. Said adhesive layer (6) is bonded to the lower surface of the fabric layer (5).

The marking element (4) represented in FIG. 2 further comprises a logo, a barcode or a name which is applied to the upper surface of the fabric layer (5). This logo, barcode or name here forms the upper outer layer (7) of the marking element (4). The appliance of said logo, barcode, name, etc. can for example be done by thermal printing, embroidery, digital printing or sublimation.

The adhesive layer (6) consists of three sublayers (1, 2, 3) namely a first sublayer (1), a second sublayer (2) and a third sublayer (3). The first sublayer (1) forms an outer surface of the marking element (4), is provided to be attached to a textile by heat and pressure and is attached to the second sublayer (2). The third sublayer (3) is bonded to the fabric layer (5) and to the second sublayer (2). For the third sublayer (3) to be bonded to the fabric layer (5) and the second sublayer (2), a part of the third sublayer (3) is penetrated in the fabric layer (5) and a part of the third sublayer (3) is penetrated in the second sublayer (2). The second sublayer (2) is situated between the first sublayer (1) and the third sublayer (3) and is bonded on the one hand to the third sublayer (3) and on the other hand to the first sublayer (1). To form the latter bond, a part of the first sublayer (1) is partly penetrated into the second sublayer (2).

This second sublayer (2) forms a barrier between the first sublayer (1) and the third sublayer (3) and makes sure that the first sublayer (1) and the third sublayer (3) do not mix during the patching of the said marking element (4) to a textile, during the industrial washing of the textile and during the removal of said marking element (4) from the textile. To perform its function, the second sublayer (2) is made of a thermoset urethane with a decomposition temperature of above 250° C. The attachment/patching of the marking element (4) to a textile and also the removal of said marking element (4) from said textile is normally done at temperatures of below 210° C. Since the second sublayer (2) is made of thermoset which does not decompose at 210° C., this second sublayer (2) will not alter during the patching/removal of said marking element (4) and will always be able to perform its barrier function.

The first sublayer (1) is substantially made of a polyester-based thermoplastic urethane and the third sublayer (3) is substantially made of a different polyester-based thermoplastic urethane.

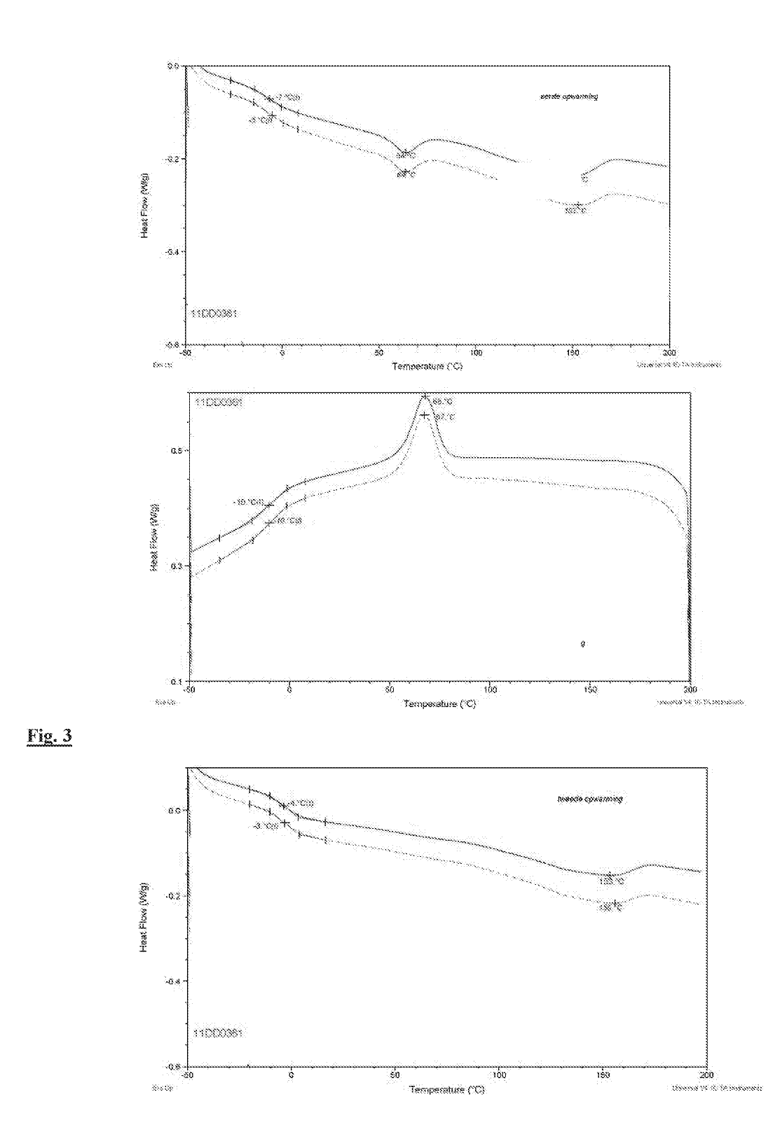

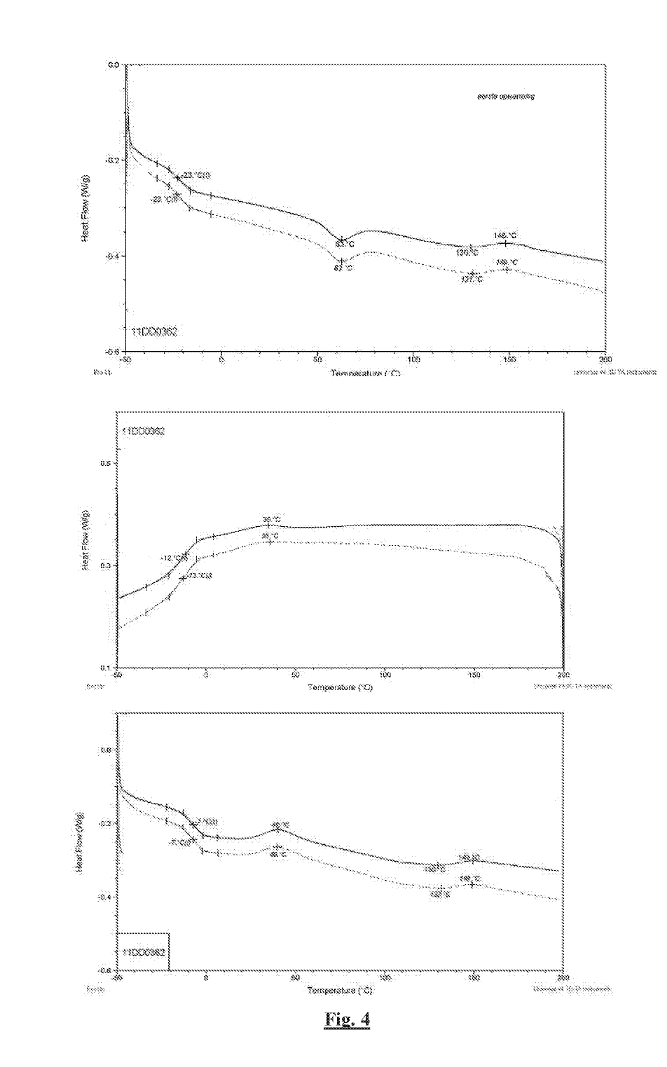

The first sublayer (1) is less crystalline than the third sublayer (3). This can be seen on the DSC curves of said sublayers (1, 3) shown in FIGS. 3 and 4. These curves are made with the aid of the standards ASTM D3418 and ISO11357 and they show the heat flow (W/g) on the vertical axis and the temperature (° C.) on the horizontal axis. FIG. 3 shows the DSC curves of the third sublayer (3), respectively the curve during the first heating, the curve during the cooling down and the curve during the second heating. The curve during the cooling down shows a high crystallisation of the third sublayer (3). Because of this crystallisation, the third sublayer (3) is very well attached to the fabric layer (5) and will not loosen during the use of the marking element (4). FIG. 4 shows the DSC curves of the first sublayer (1), respectively the curve during the first heating, the curve during the cooling down and the curve during the second heating. Here it can be seen that virtually no crystallisation takes place during the cooling down. When a marking element (4) is attached to a textile, the first sublayer (1) is heated and is then cooled down. During the patching of the marking element (4) to a textile, the first sublayer (1) liquefies under the influence of heat and is pressed partly into the textile. During the cooling down, the first sublayer (1) and thus also the part of the first sublayer (1) which has been pressed into the textile, hardens. From said DSC curves it can be derived that there is virtually no crystallisation during the cooling down of said polyester based polyurethane of the first sublayer (1). Because of this, the bond between the marking element (4) and the textile can be easily removed by the appliance of heat and pressure and this without damaging the textile and/or leaving adhesive residues on the textile.

Further, as can be seen in FIG. 1, the thickness of the third sublayer (3) is higher than the thickness of the first sublayer (1), and the thickness of the first sublayer (1) is higher than the thickness of the second sublayer (2). The thickness of the first sublayer (1) is approximately 50 g/m². The thickness of the third sublayer (3) is approximately 60 g/m² and the thickness of the second sublayer (2) is approximately 25 g/m².

The first sublayer (1) further comprises tackifiers, a plasticizer and wax. The melt volume-flow rate according to ISO1133 of both the first sublayer (1) and the third sublayer (3) is situated between 10 and 15 g/10 min.

The polyester-based thermoplastic urethane of the first sublayer (1) has a melting temperature situated between 130° C. and 135° C.

The polyester-based thermoplastic urethane of the third sublayer (3) has a melting temperature situated between 150° C. and 160° C.

1. A marking element for the labelling of a textile, comprising:
a fabric layer, having an upper surface and a lower surface opposite to the upper surface; and
an adhesive layer for securing the marking element to a textile by heat and pressure;
wherein said adhesive layer is bonded to the lower surface of the fabric layer;
wherein the adhesive layer comprises at least two sublayers, the at least two sublayers comprising a first sublayer for securing the marking element to the textile by heat and pressure, wherein said first sublayer forms an outer surface of the marking element, and a second sublayer located between the first sublayer and the fabric layer, wherein the second sublayer comprises a thermoset.

2. A marking element according to claim 1, wherein the first sublayer comprises a thermoplastic urethane.

3. A marking element according to claim 1, wherein the second sublayer comprises a thermoset urethane.

4. A marking element according to claim 1, wherein the thermoset has a decomposition temperature of above 205° C.

5. A marking element according to claim 1, wherein the adhesive layer comprises a third sublayer, wherein said third sublayer is located between the second sublayer and the fabric layer.

6. A marking element according to claim 5, wherein said third sublayer is a thermoplastic urethane.

7. A marking element according to claim 5, wherein the third sublayer is bonded to the lower surface of the fabric layer and to the second sublayer.

8. A marking element according to claim 5, wherein the degree of crystallinity of the third sublayer is higher than the degree of crystallinity of the first sublayer.

9. A marking element according to claim 1, wherein the thickness of the first sublayer is between 30 and 70 g/m².

10. A marking element according to claim 1, wherein the thickness of the second sublayer is between 5 and 45 g/m².

11. A marking element according to claim 5, wherein the thickness of the third sublayer is between 40 and 80 g/m².

12. A marking element according to claim 1, wherein the first sublayer comprises tackifiers.

13. A marking element according to claim 1, wherein the first sublayer comprises a polyester-based thermoplastic urethane with a melt volume-flow rate according to ISO1133 situated between 10 and 15 g/10 min.

14. A marking element according to claim 1, wherein the first sublayer comprises a polyester-based thermoplastic urethane with a melting temperature situated between 120° C. and 140° C.

15. A marking element according to claim 5, wherein the third sublayer comprises a polyester-based thermoplastic urethane with a melting temperature situated between 140° C. and 190° C.

16. A method of removing the marking element of claim 1, which has been attached to a textile by heat and pressure, comprising applying element heat and pressure for a period between 2 and 12 seconds, wherein the maximum applied pressure is between 2 and 5 bar and the maximum applied temperature is between 120° C. and 205° C.

17. A method according to claim 16, wherein the said heat and pressure is applied for less than 8 seconds.
